(19) United States
(12) Patent Application Publication
(10) Pub. No.: US 2003/0095257 A1
(43) Pub. Date: May 22, 2003

(54) Non-contact optical polarization angle encoder

(76) Inventors: Geert Johannes Wijntjes, Chelsea, MA (US); Constantine T. Markos, Lynn, MA (US)

Correspondence Address: Iandiorio & Teska, 260 Bear Hill Road, Waltham, MA, 02451-1018, US

(21) Appl. No.: 10/288,875

(22) Filed: Nov. 6, 2002

Related U.S. Application Data
(60) Provisional application No. 60/333,288, filed on Nov. 6, 2001.

(51) Int. Cl. G01J 4/00

(52) U.S. Cl. 356/364

(57) ABSTRACT

An optically coupled rotary encoder that is capable of measuring and encoding the angle of rotation of a rotating or stationary object. A polarizer rotates synchronously with the rotatable object and inputs broadband or single frequency unpolarized light. The polarizer outputs and directs polarized light towards a plurality of fixed analyzers and light detectors. Each fixed analyzer outputs and directs further polarized light towards one of the light detectors. Each light detector outputs an electrical signal to a phase processor based upon one attribute of the further polarized light. The phase processor outputs a phase angle with high resolution (>10 bit) with high accuracy and frequency (5 Mhz). The system and method can operate in harsh environments having high temperatures, dirt and debris and is not susceptible to EMI/RFI.

### RELATED APPLICATIONS

This application claims priority to and incorporates by reference U.S. Provisional Application No. 60/333,288 filed on Nov. 6, 2001 titled OPTICAL ANGLE ENCODERS FOR ADVANCED POWER TRAINS.

### GOVERNMENT LICENSE RIGHTS

The U.S. Government has a paid up license in this invention and the right in limited circumstances to require the patent owner to license others on reasonable terms as provided for by the terms of SBIR contract number NSF00-48/CFDA#47.041, award number 0109171.

### FIELD OF THE INVENTION

This invention relates to a non-contact optical angle of rotation encoding system and method and more particularly to a system which enables measurement of the angle of rotation of a rotating or fixed object.

### BACKGROUND OF THE INVENTION

Most prior art angle of rotation encoders involve the use of code wheels, magnetic encoders or hall effect sensors. The manufacturing of code wheels requires stamping or lithographic etching, which are both expensive processes. Furthermore, the function of a code wheel is limited to optical diffraction. This constrains the size of code wheels to larger devices.

Magnetic encoders are susceptible to interference when used in high-speed systems, such as turbines. Also, magnetic encoders of the two phase (resolver) or the three phase (synchro) transmitter design, are expensive, have a limited maximum RPM and require an AC power source that further increases their cost. Hall effect sensors provide relatively low signal levels and have temperature limitations, making them vulnerable to electromagnetic interference (EMI).

Also, angle of rotation encoders have significant mass and are required to be attached to a rotating object, such as a rotating shaft, resulting in a substantial limitation upon smaller mechanical systems (such as disk drives or medical devices, etc.).

There are other types of angle of rotation encoders, such as interferometric based units and potentiometer based units. These devices are cost prohibitive and are limited with respect to the number of rotations of an object that can be accurately encoded.

### SUMMARY OF THE INVENTION

It is therefore an object of this invention to provide a non-contact optical system and method of measuring and encoding the angle of rotation of an object, that is more accurate, of higher frequency and of greater tolerance to environmental extremes than the prior art.

It is a further object of this invention to provide a system and method of accurately measuring and encoding the angle of rotation of an object with a sampling frequency substantially in excess of the prior art.

It is a further object of this invention to provide a system and method of accurately measuring and encoding the angle of rotation (orientation) of multiple stationary (non-rotating) objects.

It is a further object of this invention to provide a system and method of accurately measuring and encoding the angle of rotation of a crankshaft of an advanced automotive powertrain, such as a crankshaft of an electric or hybrid electrical vehicle.

This invention results from the realization that an improved method of measuring and encoding the angle of rotation of a stationary or rotating target object is achieved by employing a light source and a rotatable polarizer having an angle of rotation that is synchronous with the angle of rotation of a target object, by employing a plurality of analyzers (fixed polarizers), a plurality of light detectors configured to output a signal in response to at least one attribute of the light polarized by each respective one of the plurality of analyzers, and a phase processor configured to compute a value representing the angle of polarization of light directed from the rotatable polarizer in response to the input of a signal from each of the plurality of light detectors.

In a preferred embodiment, an angle of rotation encoder includes a first plurality of analyzers, each responsive to light originating from a light source and configured to polarize the light at a unique angle of polarization, a first plurality of light detectors, each configured to receive light polarized by a unique one of the first plurality of analyzers and configured to output a signal in response to at least one attribute of the polarized light and a phase processor configured to compute a value representing an angle of polarization attribute of the light originating from the light source in response to the input of the electrical signal from each of the first plurality of light detectors.

Preferably, the at least one attribute of the polarized light includes a measurement of the optical power. Preferably, the phase processor simultaneously samples the electrical signal from each of the first plurality of light detectors.

Optionally, the angle of rotation encoder can further include a second light detector configured to receive light not being polarized by any of the first plurality of analyzers.

In one embodiment, the angle of rotation encoder further includes a polarizer configured to rotate synchronously with a first object, configured to be responsive to light originating from the light source and configured to direct light originating from the light source to the first plurality of analyzers. In this embodiment, the first object is rotatable and the polarizer is configured to rotate synchronously with the first object.

In one embodiment, the angle of rotation encoder further includes a polarizer configured to have an angle of rotation that is synchronous with a first object, configured to be responsive to light originating from the light source and configured to direct light originating from the light source to the first plurality of analyzers. Optionally, the polarizer is disposable or detachable and re-usable on at least a second object.

In one embodiment, the first plurality of analyzers includes at least three analyzers that each have a unique angle of polarization. Preferably, the first plurality of analyzers includes three analyzers having angles of polarization approximately 120 degrees apart.

In one embodiment, the polarizer is attached to the first object and reflecting light originating from the light source towards the first plurality of analyzers. In another embodiment, the polarizer is attached to the first object and allows the passage of light originating from the light source towards the first plurality of analyzers. Optionally, the light originating from the light source is transmitted to the polarizer through an optical fiber. Optionally, the first plurality of light detectors receives light from a unique one of the first plurality of analyzers through an optical fiber.

In some embodiments, the angle of rotation encoder further includes a non-polarizing light beam splitter configured to receive light from the polarizer and to output at least a first plurality of light beams, each of the light beams being directed to a unique one of the first plurality of analyzers. Optionally, at least one of the at least a first plurality of light beams is output directly towards the second light detector.

In another embodiment, the invention provides a method of encoding the angle of rotation of an object including the steps of providing a first plurality of analyzers, each responsive to light originating from a light source and configured to polarize the light at a unique angle of polarization, providing a first plurality of light detectors, each configured to receive light polarized by a unique one of the first plurality of analyzers and configured to output a signal in response to at least one attribute of the polarized light; and providing a phase processor configured to compute a value representing an angle of polarization attribute of the light originating from the light source in response to the input of the electrical signal from each of the first plurality of light detectors.

### BRIEF DESCRIPTION OF THE DRAWINGS

Other objects, features and advantages will occur to those skilled in the art from the following description of a preferred embodiment and the accompanying drawings, in which:

FIG. 1 is a simplified block diagram illustrating the basic principals of encoding an angle of rotation of an object, such as a polarizer, using an analyzer (fixed polarizer) and a light detector.

FIG. 2 illustrates the intensity of light received by the light detector as a function of the relative angle of polarization of the polarizer as compared to the angle of polarization of the analyzer.

FIG. 3 illustrates the intensity of light received by the light detector as a function the relative angle of polarization of the polarizer as compared to a reference angle of polarization.

FIG. 4 is a simplified block diagram, in accordance with the invention, of a system for high precision and non-contact encoding of an angle of rotation of an object, such as a polarizer.

FIG. 5 is simplified block diagram illustrating, in accordance with an embodiment of the invention, the system shown in FIG. 4 utilizing a reflective polarizer.

FIG. 6 is simplified block diagram illustrating, in accordance with an embodiment of the invention, the system shown in FIG. 5 optical fiber links.

FIG. 7 is simplified block diagram illustrating, in accordance with an embodiment of the invention, the system shown in FIG. 4 utilizing a transmissive polarizer.

FIG. 8 is a simplified block diagram illustrating, in accordance with an embodiment of the invention, a system for non-contact encoding of the angle of rotation of an object utilizing a non-polarizing beam splitter.

FIG. 9 is a simplified block diagram illustrating, in accordance with an embodiment of the invention, a system for non-contact encoding of the angle of rotation (orientation) of multiple stationary (non-rotating) objects.

### DESCRIPTION OF THE PREFERRED EMBODIMENT

Aside from the preferred embodiment or the embodiments disclosed below, this invention is capable of other embodiments and of being practiced or being carried out in various ways. Thus, it is to be understood that the invention is not limited in its application to the details of construction and the arrangements of the components set forth in the following description of the invention or illustrated in the drawings in accordance with the invention.

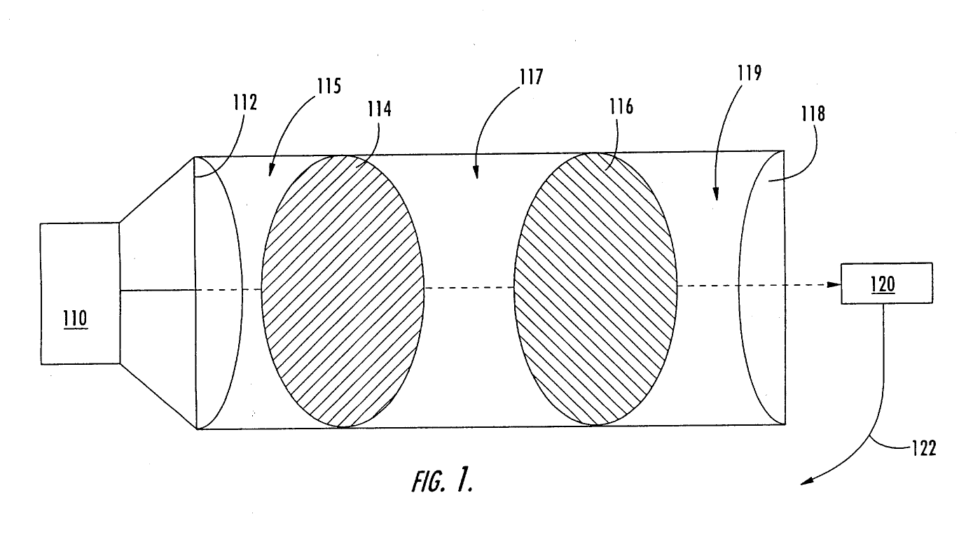

FIG. 1 is a simplified block diagram illustrating the basic principals of encoding an angle of rotation of an object, such as a polarizer 114, using an analyzer 116 (fixed polarizer) and a light detector 120. The position of the polarizer 114 may be fixed or rotating. A light source 110 projects light 115 through a lens 112 and towards a rotating polarizer 114. The light 117 passes through the rotating polarizer 114 and towards the analyzer 116. The analyzer 116 is a fixed polarizer. Light 119 passes through the analyzer 116 and through a lens 118 and towards a light detector 120. The light detector 120 generates an electric signal 122 that represents at least one attribute of the light 119 received by the light detector 120.

The rotating polarizer 114 and the analyzer 116 each polarize light at a particular angle of polarization. The angle of polarization of each device, 114 or 116, is dependent upon the angle of rotation of each device 114 or 116, respectively. When both the rotating polarizer 114 and the analyzer 116 are positioned at the same angle of polarization, the maximum amount of light passes through both the polarizer 114 and the analyzer 116. When both devices 114 and 116 are positioned at the same angle of polarization, they are positioned at the same angle of rotation.

When the polarizer 114 and the analyzer 116 are positioned at angles of polarization (rotation) that are 90 degrees apart from each other, the minimum amount of light passes through the rotating polarizer 114 and the analyzer 116. The intensity of the light 119 received by the light detector 120 is indicative of the amount of light passing through the polarizer 114 and the analyzer 116 and indicative of the relative difference between the angles the polarization (rotation) between the rotating polarizer 114 and the analyzer 116. Likewise, the amplitude of the electrical signal 122, expressed in terms of signal current, is also indicative of the intensity of the light received by the light detector 120.

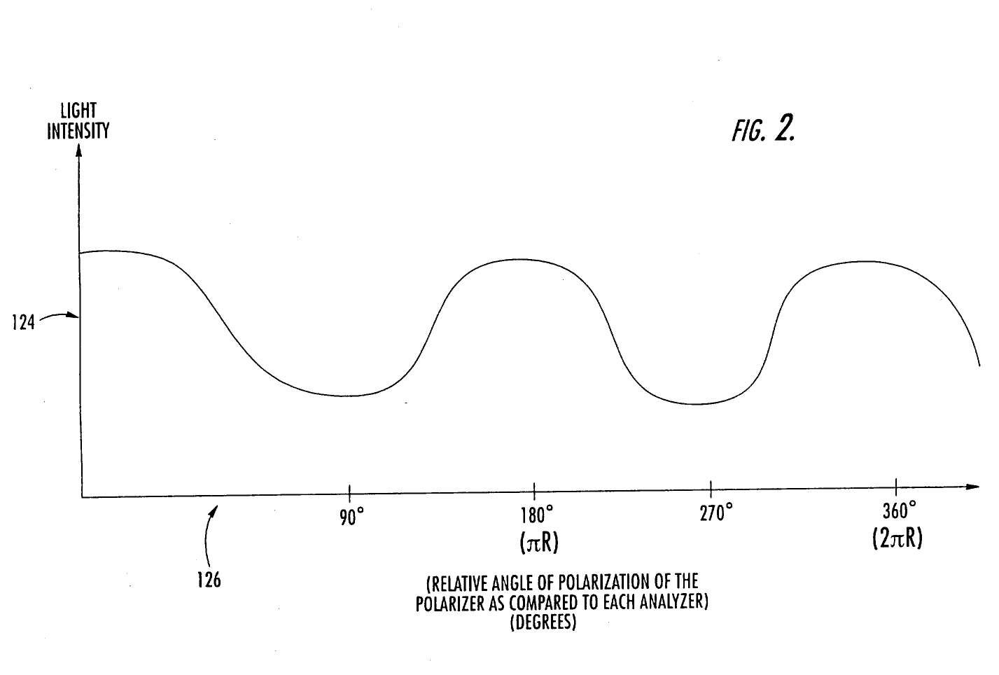

FIG. 2 illustrates the intensity 124 of light received by the light detector 120 as a function of the relative angle of polarization (rotation) of the polarizer 114 as compared to the angle of polarization (rotation) of the analyzer 116. The intensity of the light 119 is measured by the light detector 120 after the light 119 has passed through the polarizer 114 and the analyzer 116. Each half turn of the polarizer 114 alters its angle of polarization (rotation) and alters the relative difference between the angle of polarization (rotation) of the polarizer 114 and of the analyzer 116, by 180 degrees. Each half turn of the polarizer 114 causes the intensity of the light 119 to oscillate through one full sinusoidal cycle of light intensity 124 as shown.

The intensity 124 of the light 119 is maximized when the angle of polarization (rotation) of the polarizer 114 differs from the angle of polarization (rotation) of the analyzer 116 by a value of 0 degrees or by a multiple of 180 degrees. For example, the angle of polarization (rotation) difference values that maximize the intensity of the light 119 include 0, 180, 360 and 540 degrees etc.

The intensity 124 of the light 119 is minimized when the difference between the angle of polarization (rotation) of the polarizer 114 and of the analyzer 116 is a an odd multiple of 90 degrees. For example, angle of polarization (rotation) difference values that minimize the intensity of the light 119 include 90, 270 and 450 degrees etc.

In one embodiment, the light detector 120 includes a photodiode (not shown) that produces an electrical signal 122 having a current that is proportional to the intensity 124 of the light 119 received by the light detector 120. The electrical signal current (I) 122 generated by the light detector 120 expressed as a function of the relative angle of polarization (rotation) (Ω) between the polarizer 114 and a reference angle of polarization (rotation), is as follows:

I(Ω)=K[Pₒ+m Pₒ sin(2(Ω+Ωₒ))]

where (K) is a constant, (Pₒ) is an optical power value, (m) is a modulation efficiency value; (Ω) is a relative angle of polarization (rotation) value and (Ωₒ) is a relative angle of polarization (rotation) offset value.

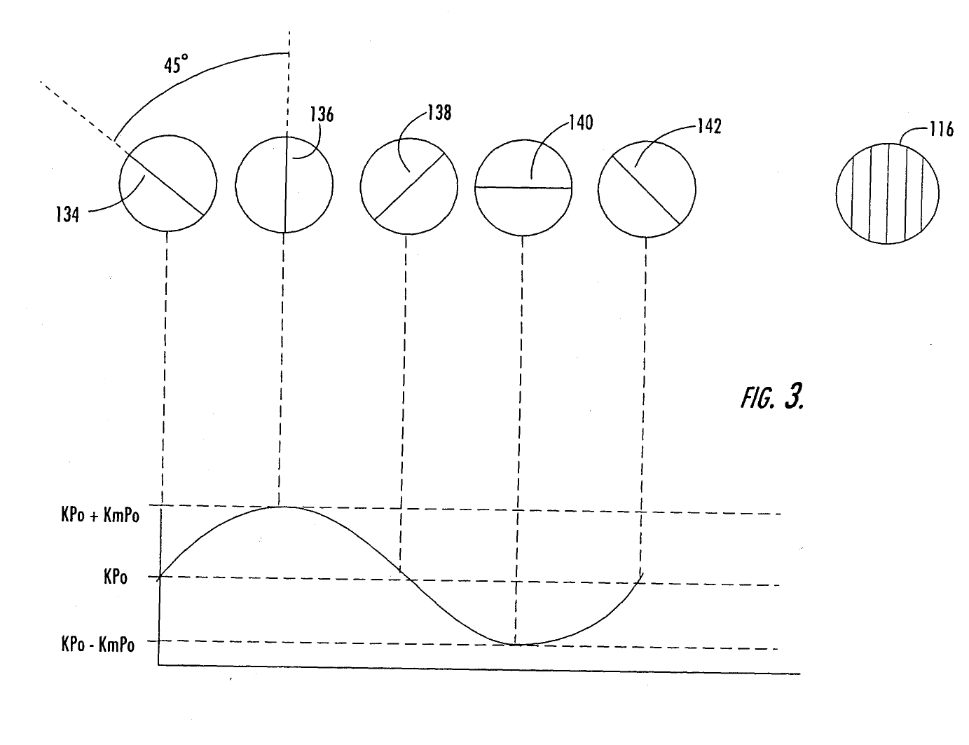

FIG. 3 illustrates the amplitude of the current I (Ω) 122 generated by the light detector 120 as a function of the relative angle of polarization (rotation) of the polarizer 114 as compared to a reference angle of polarization (rotation) 134. The amplitude of the current I (Ω) 122 generated by light detector 120 is proportional to the intensity 124 of light 119 received by the light detector 120.

The reference angle of polarization (rotation) 134 is depicted as being 45 degrees offset (counter clockwise) from a vertical angle of polarization (rotation) 136. In this illustration, the analyzer 116 is positioned at the vertical angle of polarization (rotation) 136, corresponding to Ωₒ=0 degrees.

When the polarizer 114 is positioned at the reference angle of polarization (rotation) 134, the amplitude of the current I (Ω) 122 generated by light detector 120 is equal to (K) (Po). When the polarizer 114 is positioned at the vertical angle of polarization (rotation) 136, 45 degrees offset from the reference angle of polarization, the amplitude of the current I (Ω) 122 generated by light detector 120 is equal to (K) (Po)+(K)(m)(Po).

When the polarizer 114 is positioned at 90 degrees (clockwise) offset 138 from the reference angle of polarization 134, equal to 45 degrees (clockwise) offset from the vertical angle of polarization (rotation) 136, the amplitude of the current I (Ω) 122 generated by the light detector 120 is again equal to (K) (Po).

When the polarizer 114 is positioned at 135 degrees (clockwise) offset 140 from the reference angle of polarization 134, equal to 90 degrees (clockwise) offset from the vertical angle of polarization (rotation) 136, the amplitude of the current I (Ω) 122 generated by the light detector 120 is again equal to (K)(Po)−(K)(m)(Po).

When the polarizer 114 is positioned at 180 degrees (clockwise) offset 142 from the reference angle of polarization 134, equal to 135 degrees (clockwise) offset from the vertical angle of polarization (rotation) 136, the amplitude of the current I (Ω) 122 generated by the light detector 120 is again equal to (K) (Po).

The aforementioned angles of polarization (rotation) of the polarizer 114 span one entire 180 degree sinusoidal cycle of electrical current amplitude, which is proportional to the intensity 124 of light received by the light detector 120, as shown.

In summary, when Ωₒ=0, the reference angle of polarization (rotation) of the polarizer is 45 degrees apart (counter clockwise) from a position that is aligned with the angle of polarization (rotation) of the analyzer 116. When Ωₒ=0 degrees, the amplitude of the current of the electrical signal 122 is maximized at Ω=45 degrees and at any multiple of 180 degrees plus 45 degrees. For example, the angle of polarization (rotation) difference values (Ω), which maximize the amplitude of the current of the electrical signal 122, include 45, 225, and 405 degrees etc.

The amplitude of the current I(Ω) 122 generated by the light detector 120 includes a direct current (DC) component and an alternating current (AC) component. The AC component transitions through 2 complete cycle per revolution, (1 complete cycle per half revolution), of the polarizer 114.

The maximum or minimum amplitude of the electrical signal current I(Ω) 122 may not be a constant value. For example, the maximum current may differ between the angle of polarization (rotation) values of 0, 180 and 360 degrees. Likewise, the minimum current may differ between the angle of polarization (rotation) values of 90, 270 and 450 degrees.

The amplitude of the sine wave representing the electrical signal current I(Ω) 122, is measured from the “middle” current value of the sine wave (Kpo) and not from the lowest current value to (K)(Po)−(K)(m)(Po). The DC component may raise both the minimum and maximum current values of the sine wave, but not necessarily the amplitude of the sine wave, because in theory, the DC component raises both the minimum and the maximum equally and at any one instant in time.

The value (K) is a constant that converts an optical power value of the light 119 detected by the light detector 120, expressed in units of watts, to an electrical current expressed in units of amperes. The optical power of the light 119 received by the light detector 120 is proportional to the intensity 124 of the light 119 received by the light detector 120.

The variable (Po) is an optical power value, detectable by the light detector 120, that causes the light detector 120 to generate the underlying direct current (DC). The underlying DC current is represented by (K) (Po).

The modulation efficiency variable (m), is expressed as a value between 0 and 1 and represents the efficiency of the light detector 120 with regard to its modulation of the output current 122 based upon the measured optical power of the light 119.

The relative angle of polarization (rotation) (Ω) and (Ωₒ) both express the rotational position of an object, such as the rotational position of the polarizer 114, expressed in terms of the number of whole and/or fractional rotations.

The variables (Po), (m) and (Ω) are time dependent and can change independently from each other. Consequently, the underlying DC component (KPo) and the AC component (m Pₒ sin (2 (Ω+Ωₒ)), both being dependent upon (Po), are also time dependent and can change independently from the rotation of the polarizer 114. The AC component (m Pₒ sin (2 (Ω+Ωₒ)), is additionally dependent upon (m), and can change independently from the DC component and independently from the rotation of the polarizer 114.

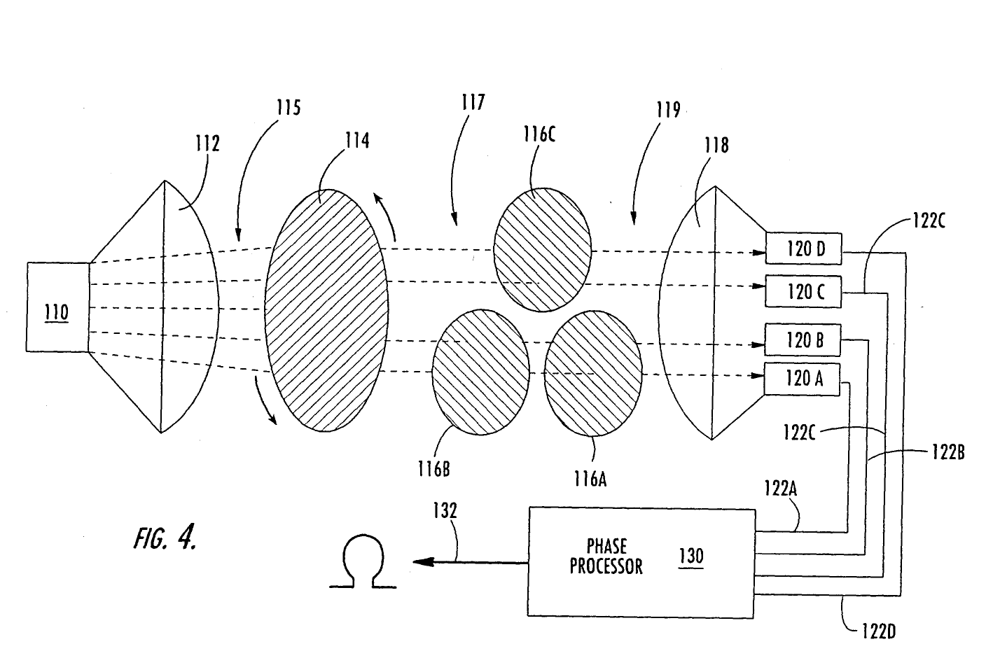

FIG. 4 is a simplified block diagram, in accordance with the invention, of a system for high precision and non-contact encoding of an angle of polarization (rotation) of an object, such as a polarizer 114. The position of the polarizer 114 may be fixed or rotating.

This embodiment employs three analyzers (fixed polarizers) 116A-116C, four light detectors 120A-120D outputting electrical signals 122A-122D into a phase processor 130. The phase processor 130 outputs a value represented by a signal 132 that encodes the angle of rotation of the rotating object 114 over time.

The phase processor 130 is capable of simultaneously sampling the electrical signals 122A-122D at a rate of 5 Mz. Sampling the angle of rotation of a rotating object at 5 Mhz far exceeds the sampling rates provided by the prior art.

Like shown in FIG. 1, a light source 110 projects light 119 through a lens 112 towards a rotating polarizer 114. The light 119 passes through a rotating polarizer 114 towards the analyzers 116A-116C. The analyzers 116A-116C are fixed polarizers. The light 119 passes through the analyzers 116A-116C and is directed through a lens 118 and towards light detectors 120A-120D. The light detectors 120A-D each generate an electric signal 122A-122D that represents at least one attribute of the light 119 received by the light detectors 120A-120D.

Each of the analyzers 116A, 116B and 116C are configured to polarize the light 119 at a unique and different angle of polarization. Preferably, the angles of polarization of the analyzers 116A, 116B and 116C are 120 degrees apart. Each of the light detectors 120A, 120B and 120C are configured to receive the light 119 polarized by a unique one of the analyzers 116A, 116B and 116C, respectively. Light detector 120A receives light only passing through analyzer 116A. Light detector 120B receives light only passing through analyzer 116B. Light detector 120C receives light only passing through analyzer 116C. Light detector 120D is configured to receive light 119 that passes through the polarizer 114 but that does not pass through the analyzers 116A-116C.

Each of the light detectors 120A-120D output an electrical signal having a current amplitude that is proportional to the intensity (power) of the light 119 received by it 120A-120D. These electrical signals 122A-122D are simultaneously transmitted to the phase processor 130. The phase processor 130 processes these signals 122A-122D and outputs a signal 132 representing the angle of rotation of the polarizer 114 for each instance in time over a period of time.

Each of the three simultaneous electrical signals 122A-122C are dependent upon the same instantaneous value of (Po), (m) and (Ω) at one instance in time. Each of the simultaneous electrical signals depends upon a unique and different (Ωo) which is dependent upon the unique angle of polarization of the analyzer 116A-116C associated with the particular electrical signal 122A-122C.

The 3 simultaneous electrical signals 122A-122C provide 3 independent equations for I(Ω) that each have 3 unknown variables (Po), (m) and (Ω). The 3 equations that model each of the electrical signals 122A-122C (I_{R}, I_{S}, I_{T}) are listed below.

I_{R}(Ω)=K[Pₒ+m Pₒ sin(2(Ω+0))]

I_{S}(Ω)=K[Pₒ+m Pₒ sin(2 (Ω+⅓))]

I_{T}(Ω)=K[Pₒ+m Pₒ sin(2(Ω+⅔))]

The orientation of the angle of polarization for each analyzer 116A-116C are offset by 60°, (120° electrical), thereby producing 3 signals that in principle are equal except for a 120° ⅓ cycle phase difference. Having three independent equations with three unknowns allows for an unambiguous solution for Ω, modulo (½ cycle or shaft turn).

Mathematically, these three signals can be transformed (condensed) into a pair of quadrature signals, sine and cosine by the algebraic step, the equivalent of a Schott-T transformation. These quadrature signals are listed below.

I_{X}=√3/2(S−T)=Km Pₒ sin 2 Ω

I_{Y}=R−½(S+T)=Km Pₒ cos 2 Ω

These two quadrature signals are without the DC component and are thus centered on zero. The angle of rotation of the polarizer 114 and of an associated object is then given by

Ω=tan⁻¹(I_{X}/I_{Y})

where Ω is the encoded angle of rotation of the polarizer 114. The angle of rotation calculation is expressed in terms of modulo (½ a shaft turn), and absolute within that increment of ½ a shaft turn. Absolute encoding over a full rotation requires indexing.

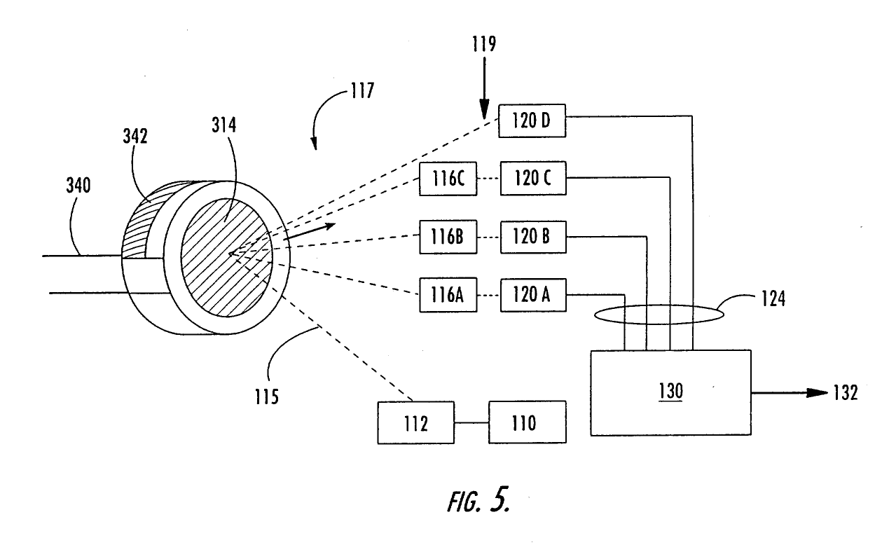

As shown in FIG. 5, a light and dark ring 342A, 342B are marked on the exterior of the polarizer 314 to act as an index. Each ring 342A, 342B identifies a particular ½ of a rotation of the polarizer 314. This index information resolves the modulo of ½—a rotation ambiguity of the polarizer 314 and facilitates the encoding of the absolute angle of rotation over 360 degrees, a full rotation of the polarizer 314.

Light detector 120D is configured to detect light reflecting off of the light 342A and the dark ring 342B. In some embodiments, the light reflecting off of the light 342A and the dark ring 342B originates from the light source 110. In other embodiments, the light reflecting off of the light 342A and the dark ring 342B originates from a source other than the light source 110.

The phase processor 130 processes the intensity of the light received by the light detector 120D in order to determine which half of a full rotation of the polarizer 314, that the polarizer position currently resides in at a particular instant in time.

Hence, (Po), (m) and (Ω) can be solved for mathematically, for each instance in time over a period of time. Solving for (Ω) reveals the angle of polarization (rotation) of the polarizer 114, and of any rotating object (not shown) rotating synchronously with the polarizer 114, at each instance in time over a period of time.

FIG. 5 is simplified block diagram illustrating, in accordance with an embodiment of the invention, the system shown in FIG. 4 utilizing a reflective polarizer 314. The reflective polarizer 314 is disposed perpendicular to the longitudinal axis of a rotating shaft 340. The polarizer 314 rotates synchronously with the rotating shaft 340. Light 115 emitted from a light source 110 and the lens 112 is directed towards the reflective polarizer 314. The reflective polarizer 314 reflects the light 117 emitted from the light source 110 and the lens 112 and redirects it towards the three analyzers 116A-116C.

Light 117 reflected from the reflective polarizer is polarized according to the angle of polarization (rotation) of the reflective polarizer 314. Light 115 emitted from the light source 110 and the lens 112 is preferred to be unpolarized. Each rotation of the rotating shaft 340 causes one rotation of the reflective polarizer 314. Each rotation of the reflective polarizer 314 reflects light 119 that generates two full sinusoidal cycles of light intensity 124 as measured by the light detectors 120A-120C. Electrical signals 122A-122D are transmitted to the phase processor 130 via communications channels 124.

The index rings 342A, 342B are markings that provides information that identifies which half of a rotation that the angle of rotation of the polarizer 314 is currently residing in. Each half of a rotation corresponds to one sinusoidal cycle of light intensity 124 of the light 119 as measured by each light detector 120A-120C.

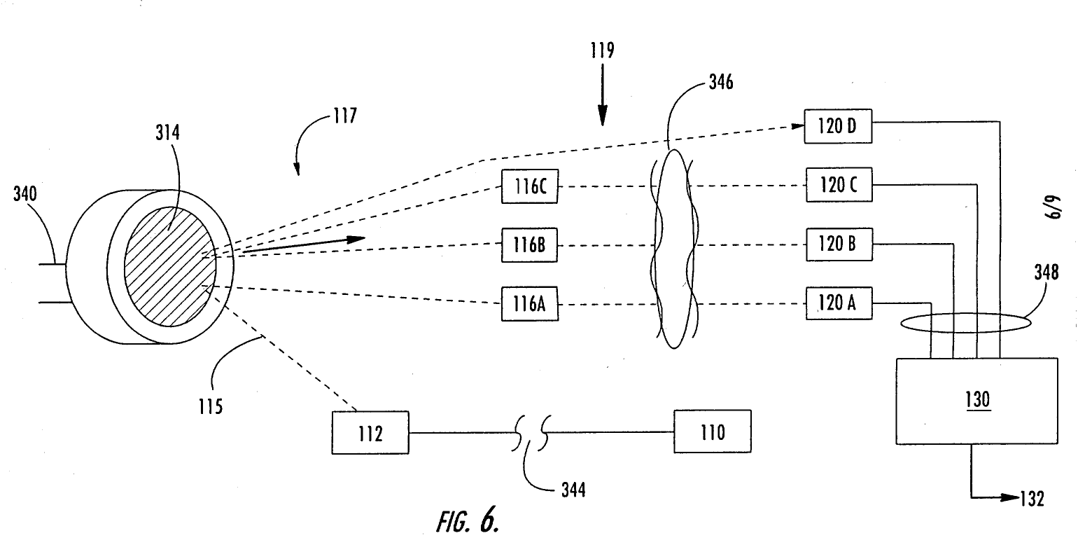

FIG. 6 is simplified block diagram illustrating, in accordance with an embodiment of the invention, the system shown in FIG. 5 utilizing optical fiber links 344, 346 and 348. Optical fiber 344 transmits light 115 emitted from the light source 110 to the lens 112. Optical fiber 346 transmits light passing through each analyzer 116A-116C to each respective light detector 120A-120C. Optical fiber 344 is preferably a non-polarizing optical fiber. Optical fiber 346 transmits a signal output from each respective light detector 120A-120D to the phase processor 130.

Use of the optical fibers enables the light source 110 and the light detectors 120A-120D to be placed outside of an extreme environment. This enables the more sensitive portions of the system to be protected from electromagnetic interference (EMI) and RFI related problems.

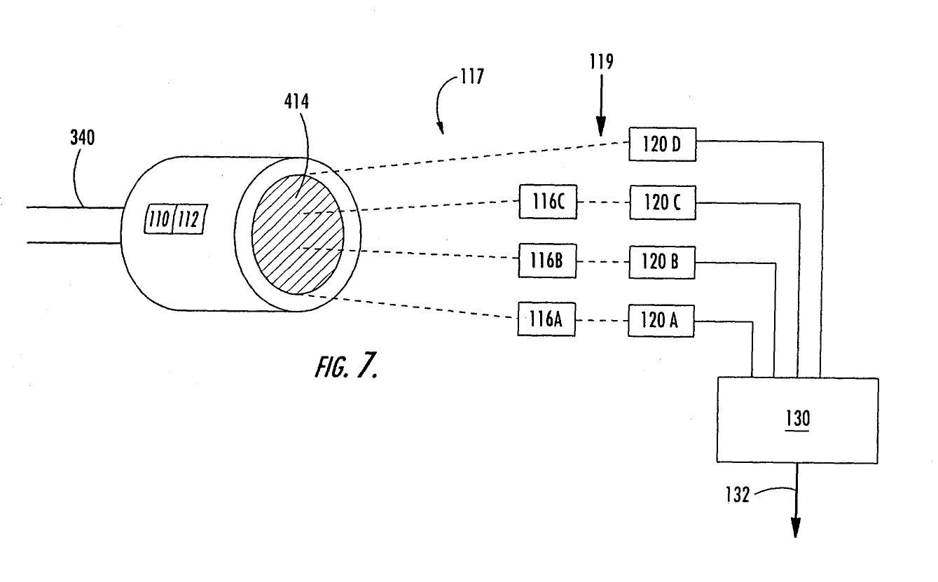

FIG. 7 is simplified block diagram illustrating, in accordance with an embodiment of the invention, the system shown in FIG. 4 utilizing a transmissive polarizer 414. The transmissive polarizer 414 is disposed perpendicular to the longitudinal axis of a rotating shaft 340. The polarizer 414 rotates with the rotating shaft. The light source 110 may of may not rotate with the rotating shaft 340.

The light 119 emitted from a light source 110 and passing through the lens 112 is directed through the transmissive polarizer 414 and towards the three analyzers 116A-116C. The light 119 passing through the transmissive polarizer 414 is polarized by the transmissive polarizer 414 according to its current angle of polarization (rotation). The light 119 emitted from the light source 110 and passing through the lens 112, is preferred to be non-polarized.

Each rotation of the rotating shaft 340 causes one rotation of the transmissive polarizer 414. Each full rotation of the transmissive polarizer 314 reflects light 119 with two full cycles of polarization. After passing through each analyzer 116A-116C, the light 119 transitions through 2 full sinusoidal cycles of light intensity as measured by each light detector 120A-120C.

The index ring 342 is a marking that provides information that identifies which 180 degree half of the polarizer rotational cycle that the polarizer 414 currently resides in. Each half of a rotation corresponds to one sinusoidal cycle of transmitted light intensity as measured by each light detector 120A-120C.

Like shown in FIG. 6, fiber optic cables can be employed for the embodiment shown in FIG. 7. An optical fiber can transmit light emitted from the light source 110 to the lens 112. An optical fiber 346 can transmit light passing through each analyzer 116A-116C to each respective light detector 120A-120C. An optical fiber 346 can transmit a signal output from each respective light detector 120A-120D to the phase processor 130.

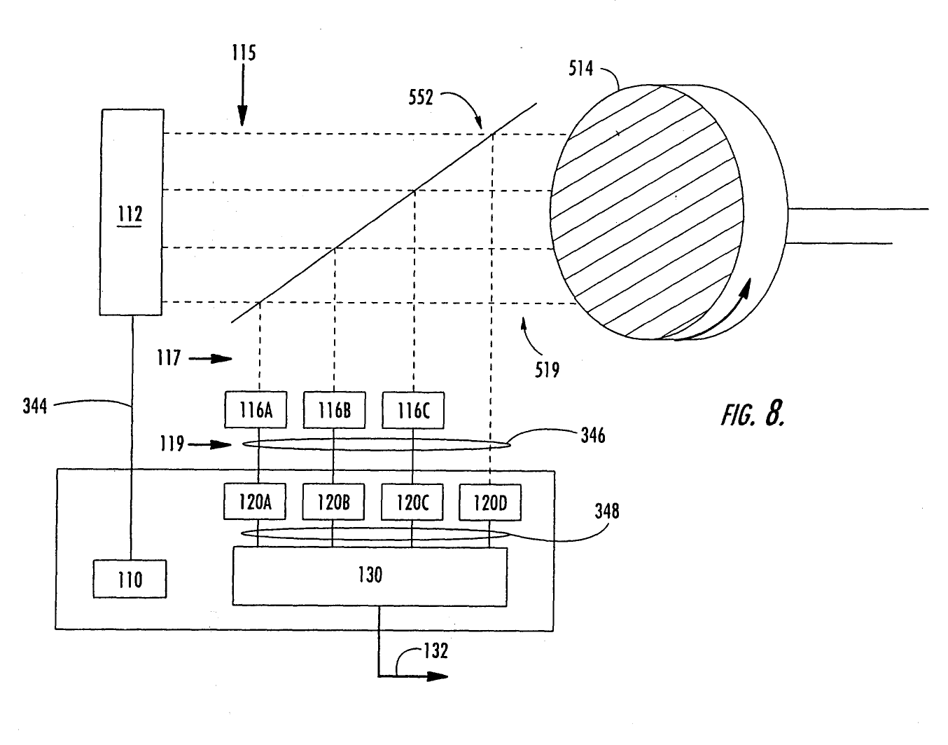

FIG. 8 is a simplified block diagram illustrating, in accordance with the invention, a system for non-contact encoding of the angle of rotation of an object utilizing a non-polarizing beam splitter 552. Some of the light emitted from the light source 110 and directed through the lens 112, passes through the non-polarizing beam splitter 552 and towards the reflective polarizer 514. The reflective polarizer 514 may or may not be rotating.

Light 519 passing through the non-polarizing beam splitter 552 reflects off of the reflective polarizer 514 and is redirected back towards the non-polarizing beam splitter 552. The non-polarizing beam splitter 552 redirects some of the light 519 reflected from the rotating polarizer 514 towards the light detectors 120A-120D. Likewise, some of the light reflected from the polarizer 514 passes through (not shown) the non-polarizing beam splitter 552 towards the lens 112 while some of this light is reflected upward (not shown) by the non-polarizing beam splitter 552.

Light passing through the analyzers 116A-116C from the non-polarizing beam splitter 552 is optionally communicated via fiber optic cable 346 to the light detectors 120A-120C. The signals generated by the light detectors 120A-120D are optionally communicated to the phase processor 130 via fiber optic cables 348. Light emitted from the light source 110 is optionally communicated to the lens 112 via a fiber optic cable 344.

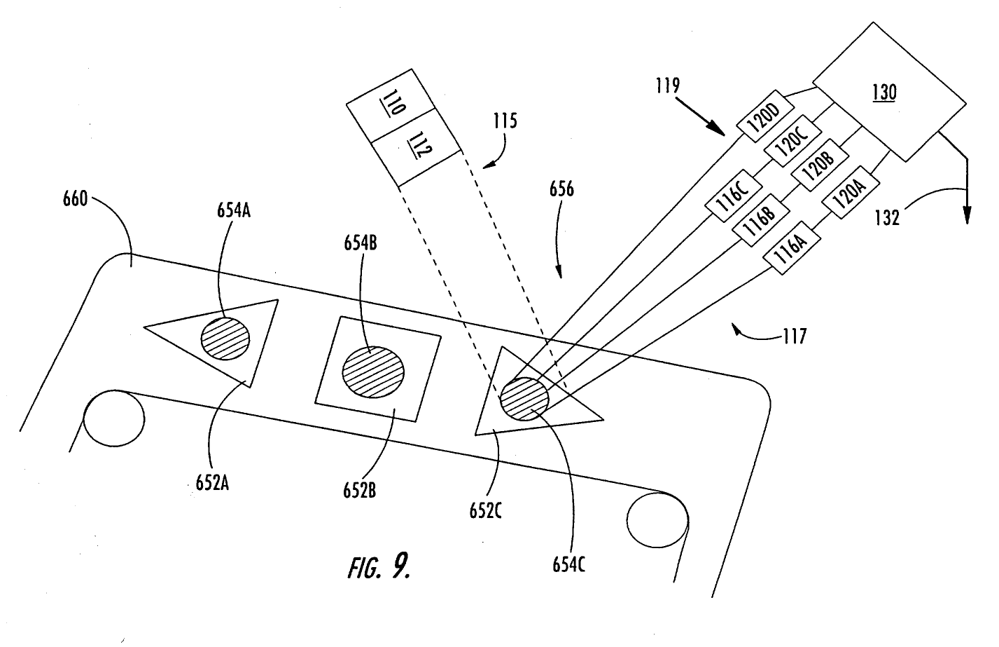

FIG. 9 is a simplified block diagram illustrating, in accordance with the invention, a system for non-contact encoding of the angle of rotation of a non-rotating object. Various objects 652A-652C are being transported along a conveyor belt 650. A polarizer 654A-654C is associated with and disposed onto each of the objects 652A-652C. Each polarizer 654A-654C is disposed onto an object 652A-652C at an angle of rotation that represents an attribute, such as the orientation of its associated object 652A-652C.

When an object 652A-652C arrives at a particular location 656 along the conveyor belt, light 115 emitted from a light source 110 and lens 112 is directed towards and reflected off of the polarizer 654A-654C associated with and disposed onto the object 652A-652C. The light 117 that is reflected by the polarizer 654A-654C is directed towards the analyzers 116A-116C. Light detectors 120A-120D and the phase processor 130 function in accordance with the description of FIG. 4.

In some embodiments, the polarizers 654A-654C are detachable and reusable. The polarizers 654A-654C can be deployed and disposed onto other objects 652A-652C to indicate their orientation. In some embodiments, the polarizers 654A-654C are disposable.

The embodiments described have various applications including but not limited to, motion control and measurement for various types of motors used for hybrid electric vehicles (HEV), elevators, radar antenna, pick and place applications, cut-to-length of spooled materials such as wires and plastics, programmable logic control units (PLC).

The invention can also be applied to the design of a Linear Variable Differential Transformer (LVDT) and a Rotary Variable Differential Transformer (RVDT) and smart toys.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Although specific features of this invention are shown in some drawings and not in other drawings, this is for convenience only, as each feature may be combined with any or all of the other features in accordance with the invention.

Other embodiments will occur to those skilled in the art and are within the following claims:

What is claimed is:

1. An angle of rotation encoder comprising:
a first plurality of analyzers, each responsive to light originating from a light source and configured to polarize the light at a unique angle of polarization;
a first plurality of light detectors, each configured to receive light polarized by a unique one of the first plurality of analyzers and configured to output a signal in response to at least one attribute of the polarized light; and
a phase processor configured to compute a value representing an angle of polarization attribute of the light originating from the light source in response to the input of the electrical signal from each of the first plurality of light detectors.

2. The angle of rotation encoder of claim 1 further comprising a second light detector configured to receive light not being polarized by any of the first plurality of analyzers.

3. The angle of rotation encoder of claim 1 further comprising:
a polarizer configured to rotate synchronously with a first object, configured to be responsive to light originating from the light source and configured to direct light originating from the light source to the first plurality of analyzers.

4. The angle of rotation encoder of claim 2 further comprising:
a polarizer configured to have an angle of rotation that is synchronous with a first object, configured to be responsive to light originating from the light source and configured to direct light originating from the light source to the first plurality of analyzers.

5. The angle of rotation encoder of claim 2 where the first object is rotatable and where the polarizer is configured to rotate synchronously with the first object.

6. The angle of rotation encoder of claim 1 wherein the at least one attribute of the polarized light includes a measurement of the optical power therefrom.

7. The angle of rotation encoder of claim 1 wherein the first plurality of analyzers includes at least three analyzers that each have a unique angle of polarization.

8. The angle of rotation encoder of claim 7 wherein the first plurality of analyzers includes three analyzers having angles of polarization approximately 120 degrees apart.

9. The angle of rotation encoder of claim 3 wherein the polarizer is attached to the first object and reflecting light originating from the light source towards the first plurality of analyzers.

10. The angle of rotation encoder of claim 3 wherein the polarizer is attached to the first object and allowing the passage of light originating from the light source towards the first plurality of analyzers.

11. The angle of rotation encoder of claim 3 where the light originating from the light source is transmitted to the polarizer through an optical fiber.

12. The angle of rotation encoder of claim 3 further comprising:
a non-polarizing light beam splitter configured to receive light from the polarizer and to output at least a first plurality of light beams, each of the light beams being directed to a unique one of the first plurality of analyzers.

13. The angle of rotation encoder of claim 3 where each of the first plurality of light detectors receives light from a unique one of the first plurality of analyzers through an optical fiber.

14. The angle of rotation encoder of claim 12 wherein at least one of the at least a first plurality of light beams is output directly towards the second light detector.

15. The angle of rotation encoder of claim 1 where the phase processor simultaneously samples the electrical signal from each of the first plurality of light detectors.

16. The angle of rotation encoder of claim 4 where the polarizer is disposable.

17. The angle of rotation encoder of claim 4 where the polarizer is detachable and re-usable on at least a second object.

18. A method of encoding the angle of rotation of an object comprising the steps of:
providing a first plurality of analyzers, each responsive to light originating from a light source and configured to polarize the light at a unique angle of polarization;
providing a first plurality of light detectors, each configured to receive light polarized by a unique one of the first plurality of analyzers and configured to output a signal in response to at least one attribute of the polarized light; and
providing a phase processor configured to compute a value representing an angle of polarization attribute of the light originating from the light source in response to the input of the electrical signal from each of the first plurality of light detectors.
